(19) United States
(12) Patent Application Publication
(10) Pub. No.: US 2022/0108275 A1
(43) Pub. Date: Apr. 7, 2022

(54) Creative Program Management Model

(71) Applicant: Arnetra Arrington, The Woodlands, TX (US)

(72) Inventor: Arnetra Arrington, The Woodlands, TX (US)

(21) Appl. No.: 17/064,989

(22) Filed: Oct. 7, 2020

(51) Int. Cl. G06Q 10/10; G06Q 10/06; G06N 5/02

(52) U.S. Cl. CPC G06Q 10/103; G06N 5/02; G06Q 10/063114; G06Q 10/063118

(57) ABSTRACT

A unique program management model that focuses on creative programs which is designed to provide a method for understanding creative visions from the very first conversation or brief session. The model includes practices that help to clearly understand the vision of the idea owner so that the goals of the vision can be outlined in clearly formed projects and executed to accomplish those defined goals. Additionally, the stages in the model include sessions that incorporates activities that help to inspire team members and motivate them to be innovative throughout the life of the program. The working methods free up the visionary, or idea owner to focus on the vision while the team focuses on being creative in creating deliverables for the program. The program leader will manage all aspects of the program to eliminate the need for the resources or the visionary to manage project activity updates on their own.

### BACKGROUND OF THE INVENTION

Program management is sometimes employed by corporations to ensure timely and successful completion of projects in many different areas of business. Typically, these projects are found in fields such as information technology, product development and marketing. Team members, with varying skill sets are assigned to the project and the project manager leads the effort. Tasks are assigned by the project manager to the team members based on their skill set. The program manager keeps track of the progress of various tasks and attempts to remedy issues that can cause the program to fall behind schedule, incorporate unplanned activity, or increase the budget. Program managers are responsible for successfully completing projects and achieving program success using specific tools and following phases in a traditional program life cycle.

Traditionally, program management success is based on the ability to meet the program's set budget, scope of work, and timeline by working through the program's activities identified in the life cycle. However, there are no program management models in place that specifically support creative programs, such as making a film, designing a fashion line, or executing a music festival. The process of clearly understanding the vision or idea is extremely essential to the view of success in program management. The ability to maintain resource or team member morale is also a key component important to program success, not readily recognized in other models. The creative process in creative programs expand beyond the limits of traditional project management practices.

### SUMMARY OF THE INVENTION

The purpose and advantages of the illustrated embodiments will be set forth in and apparent from the description that follows. Additional advantages of the illustrated embodiments will be realized and attained by the systems and methods particularly pointed out in the written description and claims hereof, as well as from the appended drawings.

In accordance with a purpose of the illustrated embodiments, in one aspect, a creative program management model for two or more projects is provided. A program management process flow captures steps from ideation to program completion. A program includes two or more projects. The method includes the general steps of: a. identifying an idea for a creative program; b. completing a session [sessions are meetings that are designed with specific agenda items and special exercises to help support the goals of the model being innovative and inspirational] where the idea owner explains the idea; c. sessions led by the program manager, exploring the vision through further explanation to gain complete understanding of concepts and expectations for end results; d. sessions led by the program manager determining all tasks, costs, resources [also termed mavens] and time lines associated with all program deliverables; and e. the management of all program activities, including vision management, resource management, risk management, change management and ideation management.

### BRIEF DESCRIPTION OF THE DRAWING

FIG. 1 illustrates a high-level view of the creative program management model's stages and components

FIG. 2 illustrates the detail of the nvizun stage of the creative program management model; it highlights the documents and sessions, also known as meetings, that are included in the stage.

FIG. 3 illustrates the detail of the discover stage of the creative program management model; it highlights the documents and sessions, also known as meetings, that are included in the stage.

FIG. 4 illustrates the detail of the create stage of the creative program management model; it highlights the documents and sessions, also known as meetings, that are included in the stage.

### DETAILED DESCRIPTION OF THE INVENTION

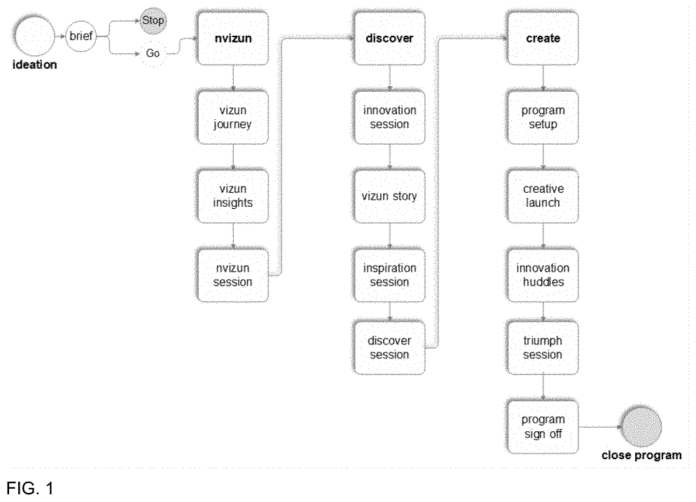

FIG. 1 illustrates a high-level view of the creative program management model's stages and components. That is, as used herein, the term “program” means a project management model in accordance with these descriptions. The model is based on a concept that focuses on vision and people, two areas that are lacked by more common forms of project management. The model starts with ideation, with respects to the owner of an idea. The model includes three stages of nvizun (pronounced envision), discover and create. Each stage of the model has activities, document completion and sessions (or meetings), that are the responsibility of the program manager or the visionary (the idea owner). The program manager leads all the sessions. The first stage, nvizun, includes the visionary completing a vizun journey questionnaire that helps the program team better understand the idea. The program team, then creates a vizun insights document that highlights specific details from the vizun journey. The vizun insights document is shared with the attendees of the nvizun session. The nvizun session is comprised of an open discussion and activities that are designed to further understand the idea of the visionary. The discover stage includes an innovation session with exercises designed to better understand what projects are needed to accomplish the idea. After the envision and innovation sessions are completed, the program team, completes a vizun story that highlights the story of the vizun, the resources [also termed mavens] needed, the partnerships recommended and the recommend projects to accomplish the program. The discover stage also includes an inspiration session that is designed to on-board resources needed to accomplish the idea, by helping all resources understand the goals of the program. The discover session is a session attended by the entire program team and the details of the tasks for the program are identified and documented. The create stage involves the program manager conducting program set up by creating documentation to manage tasks, action items, issues, budgets, and dashboards associated with the program. Next, the program manager leads a creative launch which officially kicks off the work for the program. Throughout the program, the visionary and mavens attend innovation huddles [meetings that are held weekly to discuss the progress of the program]. Once all work has been completed, the program manager leads a triumph session to obtain program sign-off from the visionary (or idea owner).

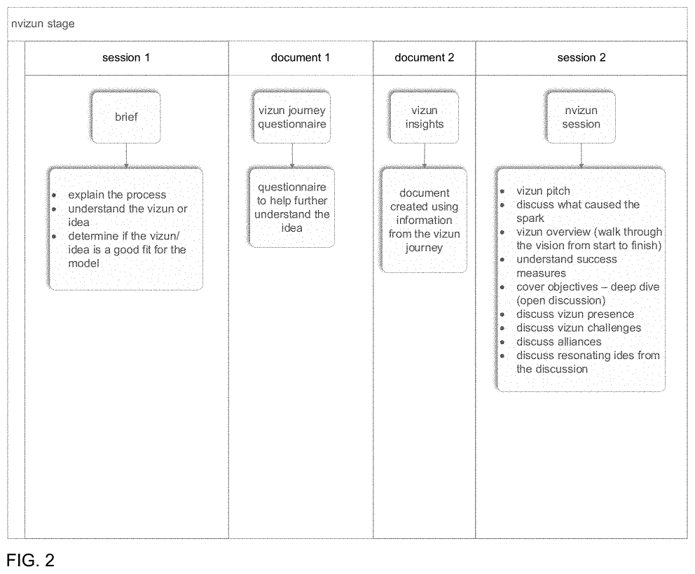

FIG. 2 illustrates the detail of the nvizun stage of the creative program management model; session #1 begins with a brief. The brief is the first step, and it is a meeting between the a visionary and program manager to initiate conversations around the idea and determine if it is a good fit for the creative program management model. If it is a good fit, the visionary will complete the vizun journey; the vizun journey is document #1 in the nvizun stage. It is a questionnaire comprised of five sections with specific questions to help the program team gain more insight into the idea, as well as to guide the visionary to better understand what goals they want to set for the idea. The vizun insights document is document #2, in the nvizun stage which is created by the program team and is a document that includes visual and written elements that recreate answers from the vizun journey questionnaire. The nvizun session is, session #2 in the nvizun stage. The nvizun session is comprised of open discussions and activities that are designed to further understand the idea of the visionary. It includes a. vizun pitch, which is a 60 second capture of the visionary's idea by the visionary; b. a discussion around what led to the idea; c. an overview of the idea's goals and objectives; d. a discussion around the visionary's expectations for the idea's reputation; e. a discussion around known challenges; f. a discussion around potential partnerships; g. an exercise that captures the visionary's ideas of what customers would say after engagement with the idea; and f. a review of words captured throughout the session that resonate with the visionary's goals for the idea.

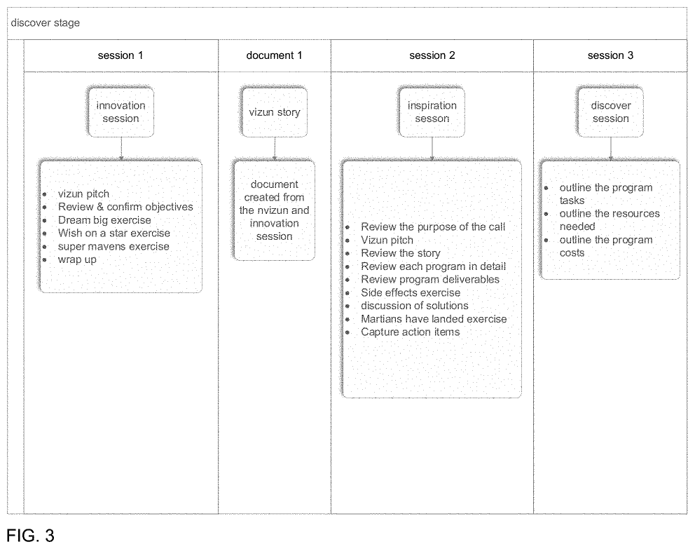

FIG. 3 illustrates the detail of the discover stage of the creative program management model; the innovation session is session #1 in the discover stage. This session covers a. vizun pitch, which is a 60 second capture of the visionary's idea by the visionary, b. a review of the objectives c. a dream big exercise designed to help uncover top objectives; d. a wish on a star exercise to help understand what goals are most important; e. a super maven exercise designed to help identify resources needed and; f. a wrap up discussion to help clarify next steps and readiness of the visionary. The vizun story is document #1 in the discover stage and is created by the program team that includes all notes from the envision & innovation sessions in a visibly pleasing way to illustrate all past discussions from the two sessions. The inspiration session is session #2 in the discover stage and includes a. an updated vizun pitch, which is an additional 60 second capture of the visionary's idea by the visionary; b. a review of the story document previously shared c. a review of each project within the program; d. an open discussion on program deliverables; e. an exercise that helps to identify known risks; f. an exercise that helps to clarify the resources understanding of the program and; g. a review of action items captured during the session. The discover session is session #3 in the discover stage and is a session that covers building out the program to understand all deliverables. There is a discussion about which resource is responsible for each deliverable and how long it would take to complete. Afterwards, the program team conducts research to associate costs with each deliverable and presents that information conclusively to the visionary in a document titled ‘the program journey.’

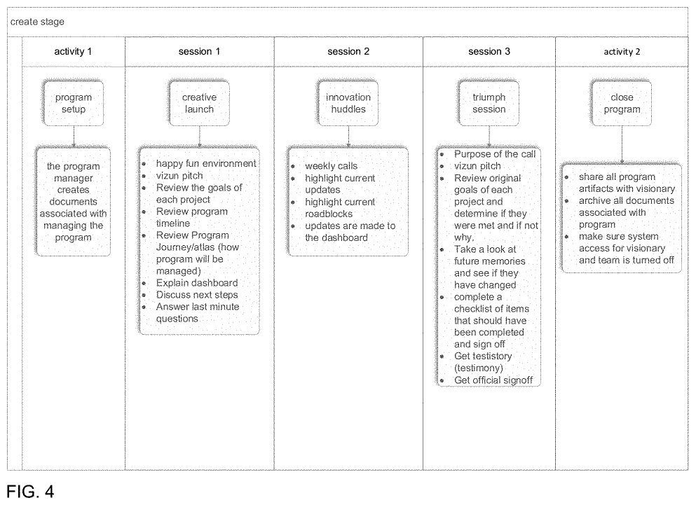

FIG. 4 illustrates the detail of the create stage of the creative program management model. The program setup begins with activity #1 in the create stage and it includes documentation that will be needed for the program. This includes, a. the program journey [as noted in FIG. 3.]; b. a program atlas, which highlights the program's action items, current ideas for improvement, current issues and resource/maven details, such as name, hours assigned, start and end dates and hourly rate and; c. program setup also covers creating a dashboard to be updated throughout the entire program and access to be provided to the visionary. Once the program is set up, the program team conducts a creative launch session, which is designed to provide a happy and enjoyable environment to kick off the program. The creative launch is session #1 in the create stage. The agenda for the creative launch includes, a. playing music; b. vizun pitch, which is a 60 second capture of the visionary's idea by the visionary; c. review of the program's timeline; d. review of program documentation, this includes the program journey [as noted in FIG. 3], and the program atlas [noted above in FIG. 4] and an explanation of the dashboard atlas [noted above in FIG. 4] and; e. review of next steps and the answering of final questions. Once the program is kicked off, the program manager will hold weekly innovation huddles for the program team to discuss program status, updates, action items and current and new concerns. The innovation huddles are session #2 in the create stage. The meeting is designed to inspire team members, keep morale high and uncover innovative ideas to help improve the program's progress. After the completion of a program's deliverables, the program manager will lead a triumph session. The triumph session's agenda includes a. review of the call's purpose; b. vizun pitch, which is a 60 second capture of the visionary's idea by the visionary; c. review original goals of the program; take a look at future memories from the envisioning session [as noted in FIG. 2.]; d. a collection of final thoughts and a testimony [also testi-story] of their experience with the program. The triumph session is session #3 in the create stage and is a celebration of work and those resources who completed the work. The close program is activity #2 in the create stage and is the program manager's responsibility to make sure the visionary has all artifacts associated with the program and to file away all document artifacts for historical purposes and turn off access to any software systems provided during the duration of the program.

What is claimed is:

1. A method of managing creative programs with two or more identified projects and an assembly comprising a plurality of components, the method including three stages, nvizun, discover, and create.

2. The method of claim 1 further comprising the nvizun stage, including one brief session, one vizun journey document, one vizun insights document and one nvizun session.

3. The method of claim 1 further comprising the discover stage, including one innovation session, one vizun story document, one inspiration session and one discover session.

4. The method of claim 1 further comprising the create stage, including one program setup activity, one creative launch session, multiple innovation huddle sessions for each week of the project, one triumph session and one close program activity.

5. The method of claim 1 further comprising the use of the naming convention of mavens as resources, and visionaries as clients in each stage.
